(19) United States
(12) Patent Application Publication
(10) Pub. No.: US 2008/0173648 A1
(43) Pub. Date: Jul. 24, 2008

(54) Trash receptacle with bag retention system

(76) Inventors: Juan C. Escobar, New York, NY (US); Paul Silberschatz, San Francisco, CA (US); Kristine Chan-Lizardo, Palo Alto, CA (US); Stephen Wahl, San Francisco, CA (US); Emily Ma, Mountain View, CA (US); Jan Raken, San Francisco, CA (US); David Thomsen, San Mateo, CA (US)

Correspondence Address: SEYFARTH SHAW LLP, 131 S. DEARBORN ST., SUITE 2400, CHICAGO, IL, 60603-5803, US

(21) Appl. No.: 11/656,581

(22) Filed: Jan. 23, 2007

(51) Int. Cl. B65F 1/14

(52) U.S. Cl. 220/495.11; 220/23.9

(57) ABSTRACT

A trash receptacle having a bag retaining system is disclosed which includes a housing having a body and a cover configured to removably engage the body, a liner having an upper rim and configured to reside within the housing, and a plurality of clips, each having a resilient arm portion and each secured to the cover such that the resilient arm portion of each biases against the upper rim of the liner, thereby retaining a disposable bag in place within the liner, when the cover engages the body. The number of clips is preferably within the range of from 2 to 10, and most preferable within the range of from 2 to 5. The plurality of clips may be removable to allow replacement of clips or adaptation to different system configurations. Alternatively, the clips may be permanently affixed to the cover of the housing. The resilient arm portion of each clip preferably biases against either an outer surface of the liner upper rim or against an inner surface of the liner upper rim.

### TECHNICAL FIELD OF THE INVENTION

The present device relates to trash-receptacles using disposable trash bags. Particularly, the present device relates to a bag retention system for holding a disposable trash bag in place within a trash receptacle.

### BACKGROUND OF THE INVENTION

It is a common practice for home and business owners, in trying to create a desired aesthetic room or area design, to conceal trash containers using a decorative outer housing. Such housings are known in the art and typically include a body and cover portions which conceal a rigid removable liner. A disposable trash bag is typically disposed within the trash receptacle liner such that a closed end of the bag sits within the liner while an open edge is draped over an upper rim of the liner. When hung in this manner, the open end of the bag covers the upper rim of the liner as well as a portion of the outside wall of the wastebasket. It is this configuration that the trash receptacle housing is intended to conceal.

Normally, a holding means of any type is not used to hold the trash bag onto the liner rim. Therefore, as soon as trash is dumped into the bag, the mouth of the bag that is draped over the rim of the liner frequently becomes dislodged from the rim and falls into the internal chamber of the trash can making it difficult to add more trash to the bag. Separation of the bag from the liner could result in fouling of the liner, lingering odors, and other such undesirable issues. Therefore, the bag may need to be as frequently re-positioned to receive additional trash. This requires a person to reach within the trash receptacle, grab the mouth of the trash bag and redrape it over the rim of the liner. Obviously, this procedure can to be rather annoying and messy for a person, to the point of avoidance.

It would be desirable to design a trash receptacle having a bag retention system that automatically retains in position the mouth of a disposable bag contained within a trash liner. There is disclosed herein such an improved bag retention system for a trash receptacle which avoids the disadvantages of prior devices while affording additional structural and operating advantages.

### SUMMARY OF THE INVENTION

In a particular embodiment, the trash receptacle having a bag retaining system comprises a housing having a body and a cover configured to removably engage the body, a liner having an upper rim and configured to reside within the housing, and a plurality of clips, each having a resilient arm portion and each secured to the cover such that the resilient arm portion of each biases against the upper rim of the liner when the cover engages the body. The clips bias against the liner into which is positioned a disposable bag. The clips thereby retain the bag along an upper rim of the liner. The number of clips is preferably within the range of from 2 to 10, and most preferable within the range of from 2 to 5.

An aspect of an embodiment of the present invention includes a plurality of removable clips, to allow replacement of clips or adaptation to different system configurations. Alternatively, the clips may be permanently affixed to the cover of the housing. The resilient arm portion of each clip preferably biases against either an outer surface of the liner upper rim or against an inner surface of the liner upper rim.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of one embodiment of a trash receptacle which might employ the present bag retention system;

FIG. 2 is a perspective view of the embodiment of FIG. 1 without the cover to show the concealed trash liner into which a disposable trash bag is usually positioned;

FIG. 3 is a perspective view of one embodiment of the trash receptacle cover, as illustrated in FIG. 1, showing a plurality of clips to be affixed to an underside surface of the cover;

FIG. 4 is a partial cross-sectional view of one embodiment of a trash receptacle having the bag retention system as the cover is being lowered onto a body housing; and

FIG. 5 is a partial cross-sectional view similar to FIG. 4, showing the cover seated onto the body housing and a bag clip biasing against the liner to secure the disposable trash bag.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

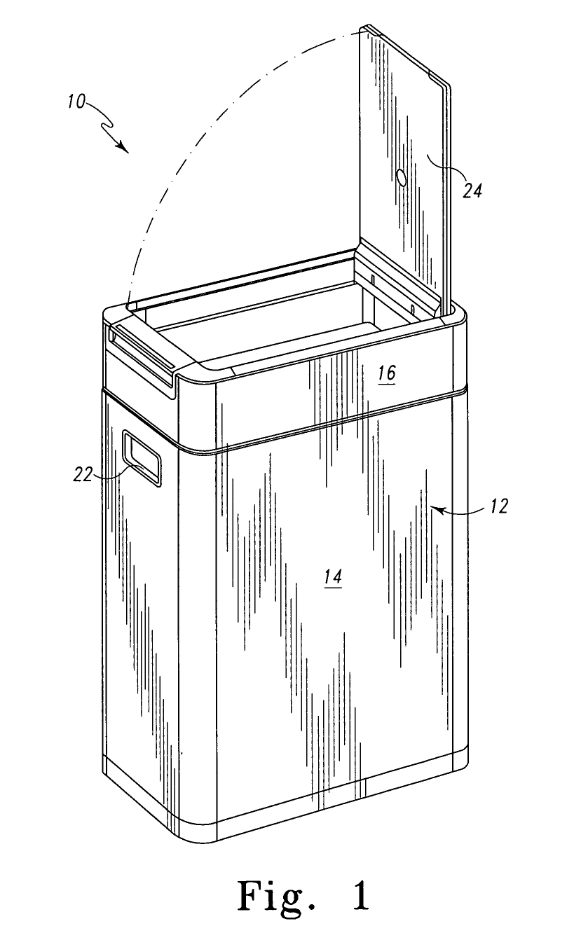

Referring to FIGS. 1-5, there is illustrated a trash receptacle having a bag retention system, generally designated by the numeral 10. The bag retention system 10 preferably includes a trash receptacle 12 comprised of a housing body 14, a cover 16, and a rigid liner 18, and a plurality of clips 20 for securing a disposable bag within the liner 18.

One embodiment of a suitable trash receptacle is shown in FIG. 1. The receptacle 12 is preferably designed to conform to a specific aesthetic design theme, while functionally providing a garbage container concealed within the receptacle 12. FIG. 1 shows a rectangular shaped housing body 14 and cover 16. The housing may be of any desired shape and size. The cover 16 is configured to removably engage the body 14. That is, the cover 16 preferably sits on the open end of the body 14, while continuing the desired aesthetic design of the housing. It is possible that the cover 16 may be designed to friction fit, snap fit, or lock onto the body 14 in any manner known to those skilled in the art.

The housing, including the body 14 and cover 16, may be made from many different materials, such as metal, especially stainless steel, molded thermoplastic, thermoset plastic, wood, composite material, stone, ceramic, cement, or a combination of these materials.

Additionally, the housing body 14 may be supplied with handles 22 for carrying the trash receptacle, and a lid 24 which opens upon actuation of a mechanism known to those skilled in the art. Other such helpful features may be added to the trash receptacle without departing from the scope of the present claims. Such features, of course, may be dictated by how they fit within the desired design aesthetics of the trash receptacle 12.

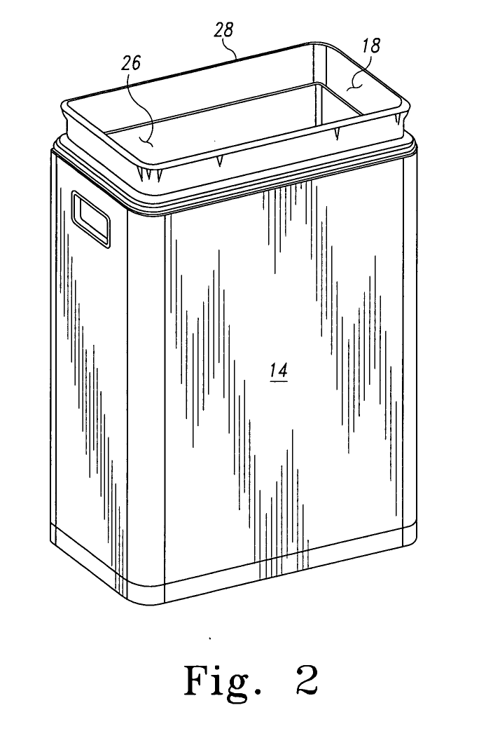

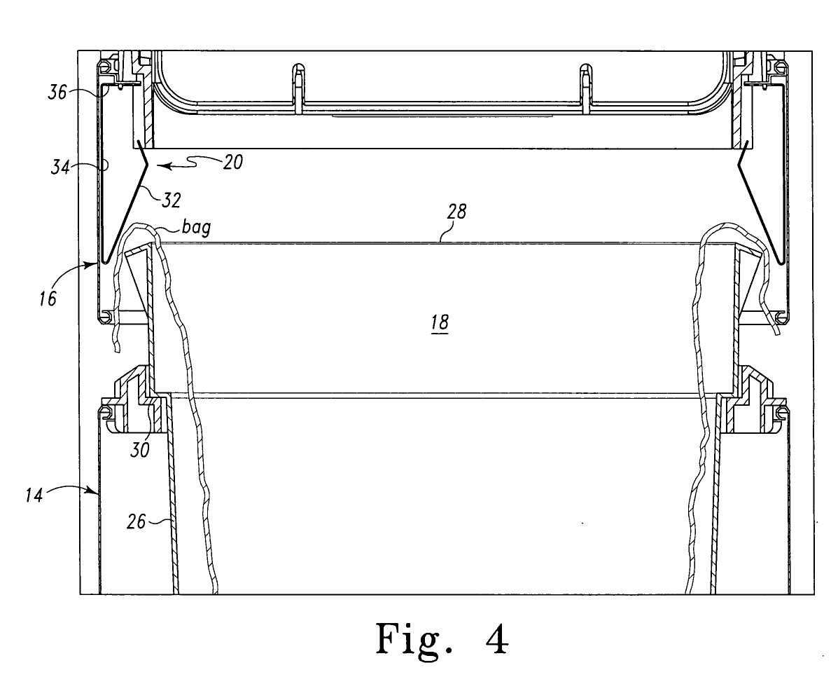

Within the housing, a liner 18 is provided having sidewalls 26, a closed bottom (not shown), and an upper rim 28. Again, the size and shape of the liner 18 is only restricted by the need to fit within and be concealed by the receptacle housing. In the embodiment of FIG. 2, the liner 18 has a shoulder 30 (FIG. 4) which allows it to sit at a certain height above the housing body 14 when placed therein. The upper rim 28 may be slightly flared to provide a point of contact for the bag clips 20, as will be discussed in more detail below.

The liner 18 is preferably a rigid plastic member capable of standing alone. It may, of course, be constructed of other suitable materials, such as metal, if desired. The liner 18 is preferably removable from the housing, so it may be provided with handles (not shown) of some kind to facilitate lifting from the housing body 14. For the same reason, it is preferred that the liner 18 be constructed to be lightweight, but sturdy. However, the liner 18 need not necessarily be removed from the housing in order to change disposable bags, as will be discussed in more detail below.

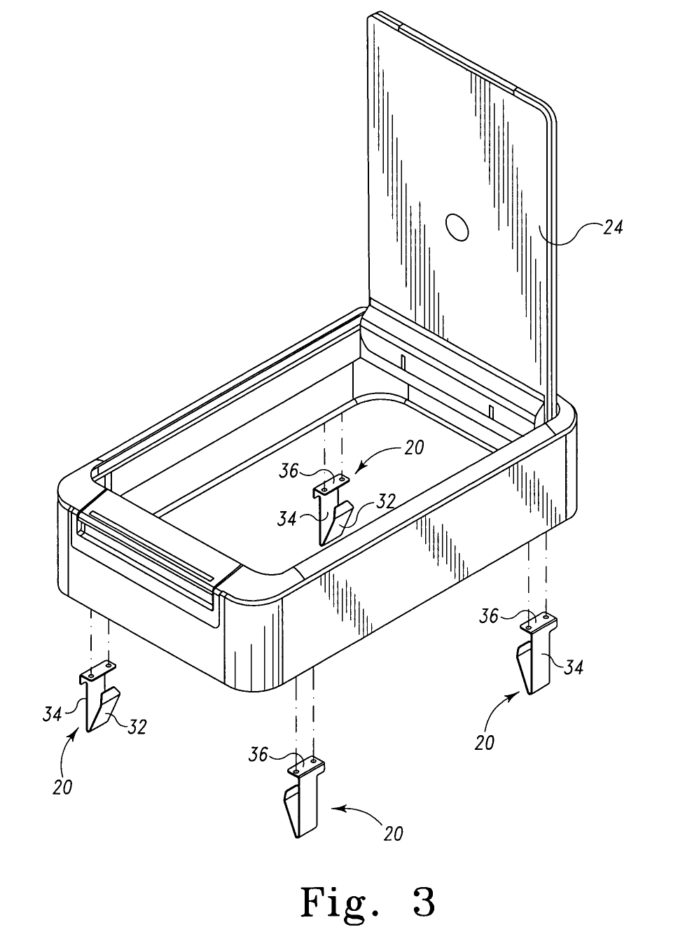

Finally, a plurality of clips 20 are affixed to the cover 16 of the housing, as shown in FIG. 3. The clips 20 are shown to be V-shaped clips with a free resilient arm portion 32 and a fixed arm portion 34. The fixed arm 34 preferably includes a plate 36 for attaching the clip 20 to the cover 16. As shown in FIGS. 3-5, the plate 36 permanently secures to an underside of the cover 16 by two screws (not shown). However, it is possible that the fixed arm 34 of the clip 20 may possess a plate (not shown) which allows the clip to be releasably fastened to the cover 20. Such alternative securing means known to those skilled in the art include friction fitting, click-fitting, pivoting tabs, and the like. By permitting the clips 20 to be removed, the number of clips 20 may be changed, broken clips may be replaced, and cleaning of the cover 16 may be facilitated.

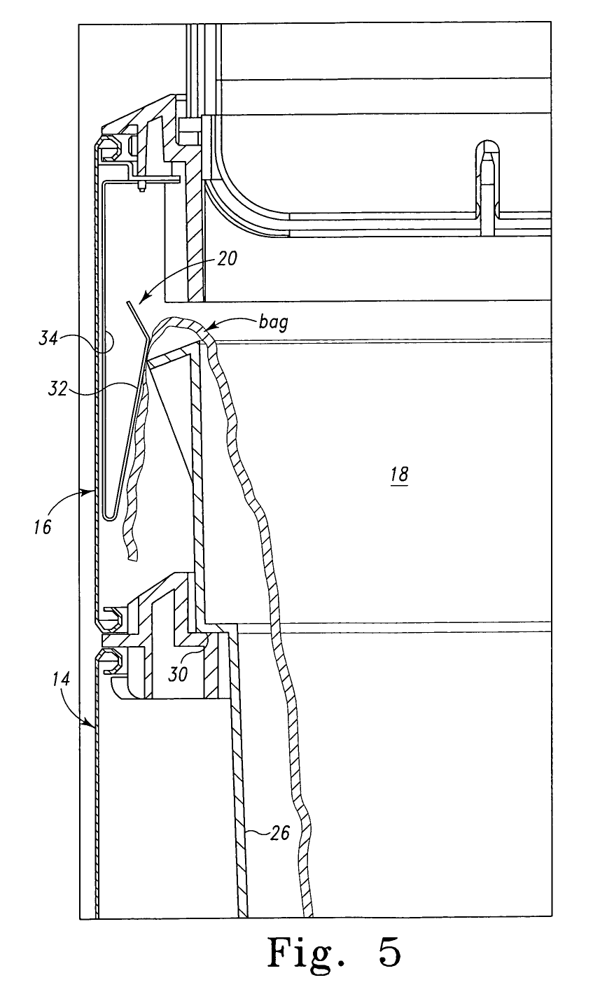

The free resilient arm portion 32 of the clip 20, as shown in FIGS. 4 and 5, is designed to bias against the liner 18 when the cover 16 is positioned onto the body 14. Preferably, the resilient arm portion 32 biases against the upper rim 28 of the liner 18, but it may be configured to bias against the outer sidewall or the inner sidewall by repositioning the clip 20 on the cover 16.

The clip 20 may be formed in a number of different shapes, so long as a resilient portion of the clip is configured to bias against the liner 18. The number of clips 20 may also change based on, for example, the receptacle and liner size, the bag thickness (i.e., thicker bags may require less clips to retain), amount of trash disposed of normally, and the type of trash being disposed of. At least two clips is preferred, with the upper limit being whatever is functionally necessary to achieve the desired result of retaining the bag in place. The clips 20 may be evenly spaced or spaced to secure the bag at key points such as at a corner, along a lengthy sidewall, or the like. Typically, two to ten clips are sufficient, with two to five clips being the most likely number of clips 20 used.

In use, with reference to FIGS. 1-5, the liner 18 may be seated with a disposable bag before or after positioning within the housing body 14. The disposable bag should be inserted into the liner 18 such that the open end of the bag may be folded, for example, a couple inches over the upper rim 28 of the liner 18. The cover 16 is then aligned with the housing body 14 and seated onto the body 14. Concealed within the cover 16, the resilient arm 32 of the clip 20 initially contacts the liner 18 at the upper rim 28, pressing also against the overlapping bag, and applies greater force against the liner 18 and bag as the cover is lowered to its final position. As the bag is filled with trash, the sidewalls of the bag are made taut, but the clips 20 maintain pressure on the liner 18 and bag to retain the bag in place.

To remove the bag when full, the cover 16 is lifted from the body 14 and either the liner 18 may be removed or the bag may be removed. A new bag is then placed within the bag as described above.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A trash receptacle comprising:
a. a housing having a body and a cover configured to removably engage the body;
b. a liner having an upper rim and configured to reside within the housing; and
c. a plurality of clips, each having a resilient portion and each secured to the cover such that the resilient portion of each biases against the upper rim of the liner when the cover engages the body.

2. The trash receptacle of claim 1, wherein the number of clips is within the range of from 2 to 10.

3. The trash receptacle of claim 2, wherein the number of clips is within the range of from 2 to 5.

4. The trash receptacle of claim 1, wherein the plurality of clip are removable from the cover.

5. The trash receptacle of claim 1, wherein the resilient portion is an arm and the arm of each clip biases against an outer surface of the liner upper rim.

6. The trash receptacle of claim 1, wherein the resilient portion is an arm and the arm of each clip biases against an inner surface of the liner upper rim.

7. The trash receptacle of claim 1, wherein the plurality of clips secure to an underside surface of the cover.

8. The trash receptacle of claim 1, wherein the plurality of clips are permanently secured to the cover.

9. The trash receptacle of claim 7, wherein the plurality of clips are permanently secured to the underside surface of the cover.

10. The trash receptacle of claim 1, wherein the plurality of clips are externally concealed by the housing when the cover engages the body.

11. The trash receptacle of claim 1, wherein the plurality of clips are internally concealed by the liner.

12. The trash receptacle of claim 10, wherein the plurality of clips are internally concealed by the liner.

13. The trash receptacle of claim 1, wherein the cover comprises an opening defined within the cover and a hinged lid positioned to close the opening.

14. A bag retaining system for a trash receptacle having an outer body shell and a cover including an opening for inputting trash to the receptacle and configured to engage the body shell, the system comprising:
a. a liner having an upper rim and configured to fit within the body shell below the cover, wherein a disposable bag placed within the liner can be folded over the upper rim of the liner; and
b. a plurality of clips affixed to the cover, each clip having a resilient arm portion which biases against the liner to thereby hold a disposable bag in place when the cover is positioned over the liner within the body shell.

15. The bag retaining system of Clam 14, wherein the number of clips is within the range of from 2 to 10.

16. The trash receptacle of claim 15, wherein the number of clips is within the range of from 2 to 5.

17. The trash receptacle of claim 14, wherein the plurality of clips are removable from the cover.

18. The trash receptacle of claim 14, wherein the resilient arm portion of each clip biases against an outer surface of the liner upper rim.

19. The trash receptacle of claim 14, wherein the resilient arm portion of each clip biases against an inner surface of the liner upper rim.

20. The trash receptacle of claim 14, wherein the plurality of clips secure to an underside surface of the cover.

21. The trash receptacle of claim 14, wherein the plurality of clips are permanently secured to the cover.

22. The trash receptacle of claim 20, wherein the plurality of clips are permanently secured to the underside surface of the cover.

23. The trash receptacle of claim 14, wherein the plurality of clips are externally concealed by the housing when the cover engages the body.

24. The trash receptacle of claim 14, wherein the plurality of clips are internally concealed by the liner.

25. The trash receptacle of claim 23, wherein the plurality of clips are internally concealed by the liner.

26. The trash receptacle of claim 14, wherein the cover comprises an opening defined within the cover and a hinged lid positioned to close the opening.
